(19) United States
(12) Patent Application Publication
(10) Pub. No.: US 2009/0006204 A1
(43) Pub. Date: Jan. 1, 2009

(54) EXPEDITED CUSTOMER ACQUISITION METHOD FOR DEBIT PAYMENT LOYALTY PROGRAM

(76) Inventor: PATRICK J. LEWIS, TWIN FALLS, ID (US)

Correspondence Address: PEDERSEN & COMPANY, PLLC, P.O. BOX 2666, BOISE, ID, 83701, US

(21) Appl. No.: 12/113,859

(22) Filed: May 1, 2008

Related U.S. Application Data
(60) Provisional application No. 60/915,429, filed on May 1, 2007.

(51) Int. Cl. G06Q 30/00

(52) U.S. Cl. 705/14

(57) ABSTRACT

An expanded customer loyalty program includes an expedited method for acquisition of customers who use the debit method of payment for rewards. New customer acquisition may be accomplished by expeditiously associating the merchant's loyalty card and a customer identification number with the customer's current checking account. The customer acquisition system for a debit payment loyalty program comprises some hardware at the merchant's location, namely: 1. a two-sided check imager with franking functionality; and/or 2. a two-dimensional bar code reader (compatible with drivers' licenses in more than 20 States); and/or 3. a magnetic stripe reader for loyalty cards (also compatible with drivers' licenses in about 26 States); and 4. a printer; and 5. a pin-pad; and 6. an Internet-enabled communication and information processing device. The preferred customer acquisition system comprises some method steps to be performed at the merchant's location, namely: a. a customer provides the retail clerk with the customer's check, id card, and the merchant's loyalty card; and b. the retail clerk provides the customer with complete disclosure of the terms and conditions of the debit payment/customer loyalty rewards program; and c. the clerk then franks the check and authorizes the merchant's debit payment customer loyalty program; d. the customer then signs the check, confirming the authorization; e. the clerk then scans the customer's id (driver's license), runs the check through the imager, and swipes the loyalty card; and f. the customer then uses the pin-pad to create a 4 digit customer id number; and g. all information extracted from the customer's franked and signed check, id card, merchant's loyalty card, and pin-pad 4 digit id number is transmitted to the merchant's (or its loyalty program administrator's) servers and promptly approved or declined. If approved, from that time on, the customer will be able to use the merchant's loyalty card as a debit instrument at participating location of the merchant(s).

### DESCRIPTION

This application claims priority of U.S. Provisional Application Ser. No. 60/915429, filed May 1, 2007, and entitled “Expedited Customer Acquisition Method For Debit Payment Loyalty Program,” which is hereby incorporated by reference.

### BACKGROUND OF THE INVENTION

1. Field of the Invention

This invention relates generally to customer loyalty programs, especially in retail operations. More specifically, this invention relates to an expedited method for signing up customers in a merchant's debit payment loyalty program.

2. Related Art

Presently, participating merchants in merchant debit payment customer loyalty programs rely on customers filling out authorization forms, providing voided checks for the account and routing information, and then in-house processing of the authorization/account/routing information before a customer can become allowed to begin using the debit method of payment. Or, in the alternative, merchants ask the customer to go home and register for the merchant's service on-line, which makes the authorization/account/routing information process electronic, and speeds up the process—if the customer ever gets around to it. Generally, this sign-up process is known as customer acquisition - signing up new loyalty program participants.

Because of NACHA (The Electronic Payments Association), and other, often governmental, rules regulating this type of financial transaction, it is required to fully disclose the ACH (Automatic Cleaning House) process to the customer before obtaining authorization. In addition, this disclosure before authorization must be documented. However, despite the two alternative current approaches described above for customer acquisition, the success rate for acquisition for merchant debit payment loyalty programs has been low—probably due to the inconvenience to the customer. This has been the case even in the face of relatively greater rewards currently offered to customers who pay by the debit method.

Merchants everywhere are interested in the in-house debit method of payment. Typically, the in-house debit method costs merchants 10-20% of the fees charged in a similar credit card or bank debit card transaction. Also, the cost is about 50% of the cost of processing a paper check. Therefore, the retail community is very anxious to see this merchant debit payment system work. Therefore, there is a need for an expedited customer acquisition method for merchant debit payment loyalty programs. This invention addresses this need.

### SUMMARY OF THE INVENTION

The invention is an expanded customer loyalty program to include an expedited method for acquisition of customers who use the debit method of payment for rewards. Current regulations require participating merchants to solicit their customers to authorize ACH debit of their checking accounts to pay for purchases. According to the present invention, this will be accomplished by expeditiously associating the merchant's loyalty card and a customer identification number with the customer's current checking account. Then, any transaction according to the method of the invention will be processed via the ACH network to be cleared through the U.S. Federal Reserve, including identifying appropriate rewards to the cardholder's account.

According to the present invention, a customer acquisition system for a debit payment loyalty program comprises some hardware at the merchant's location, namely:
1. a two-sided check imager with franking functionality; and/or
2. a two-dimensional bar code reader (compatible with drivers' licenses presently in more than 20 States of the United States); and/or
3. a magnetic stripe reader for loyalty cards (also compatible with drivers' licenses presently in about 26 States); and
4. a printer; and
5. a pin-pad; and
6. an Internet-enabled communication and information processing device. Most of the hardware components #1-#6 above are already present in most retail locations—adding to the convenience and attractiveness of the present invention.

Also, according to the present invention, a customer acquisition system for a debit payment loyalty program comprises some method steps to be performed at the merchant's location, namely:
a. a customer provides the retail clerk with the customer's check, identification (id) card (for example, a current driver's license) and the merchant's loyalty card; and
b. the retail clerk provides the customer with complete disclosure of the terms and conditions of the debit payment/customer loyalty rewards program; and
c. the clerk then franks the check to indicate that the customer acknowledges the complete disclosure, and authorizes the merchant's debit payment customer loyalty program;
d. the customer will then sign the check, confirming the authorization;
e. the clerk will then scan the customer's id (driver's license, for example), run the check through the imager, and swipe the loyalty card; and
f. the customer will then use the pin-pad to create a 4 digit customer id number; and
g. all information extracted from the customer's franked and signed check, id card, merchant's loyalty card, and pin-pad 4 digit id number is transmitted to the merchant's (or its loyalty program administrator's) servers and promptly approved or declined. If approved, from that time on the customer will be able to use the merchant's loyalty card as a debit instrument at any merchant's participating location. Notably all the customer steps above may be quickly and conveniently performed in one visit at the merchant's location.

### BRIEF DESCRIPTION OF THE DRAWINGS

FIG. 1 is a schematic, structural diagram of the hardware components of one embodiment of the invention.

FIG. 2 is a schematic, flow diagram of the method step components of one embodiment of the invention.

### DESCRIPTION OF THE PREFERRED EMBODIMENTS

Referring to the Figures, there are depicted several embodiments, but not all embodiments, of the present invention.

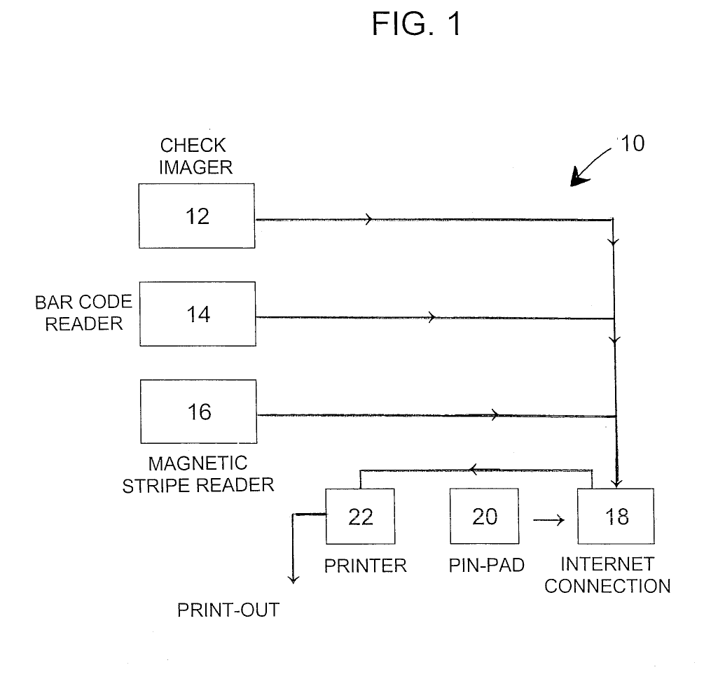

In FIG. 1 is depicted a schematic diagram of the hardware components 10 of the present invention. Depicted therein are check imager 12, bar code reader 14, and magnetic stripe reader 16. These are input devices that obtain information regarding the customer's identification (id) card, check or other banking account, and merchant's loyalty card. Therefore, any equivalent conventional input device(s) will serve instead for these three input devices, provided the conventional input devices(s) are capable of digitally providing information regarding the customer's id card, bank account, and loyalty card to the system's internet connection 18. Preferably, check imager 12 has franking capability, which means that the check inserted into the imager may be marked by the imager 12 being used for the authorization and acknowledgment purposes herein.

Likewise, pin-pad 20 is also an input device to internet connection 18. Pin-pad 20 is for entering a customer's four-digit customer id number, in addition to the customer's i.d. card, bank, account, and loyalty card information. Therefore, pin-pad 20 may also be equivalent to (an) other conventional input device(s), provided the other input device(s) will also serve instead to digitally provide the required 4 digit customer id number to the system's internet connection 18.

Therefore, depending on system or location needs and capabilities, the functions of the above input devices, check imager 12, bar code reader 14, mag stripe reader 16 and pin-pad 20, may be combined into, or served instead by, a different input device(s), for example, a keyboard and processor. All that is required is that the necessary information for approval of set-up of a new customer account be obtained and provided digitally via the input devices to the system's internet connection 18.

In this vein, in some systems, some of the information described above may be optional. For example, even though a customer i.d. card, for example, a currently driver's license, may be preferred in order to reduce the merchant's risk, it still may not be necessary in order to set-up a new customer account. Therefore, the information required to be obtained by the input device(s) may vary from merchant-to-merchant, and even from location-to-location.

Optionally, the hardware components 10 of the present invention may also comprise printer 22. This way, for example, a sign-up receipt with account number and awards program information may be printed at the merchant's location for each new customer.

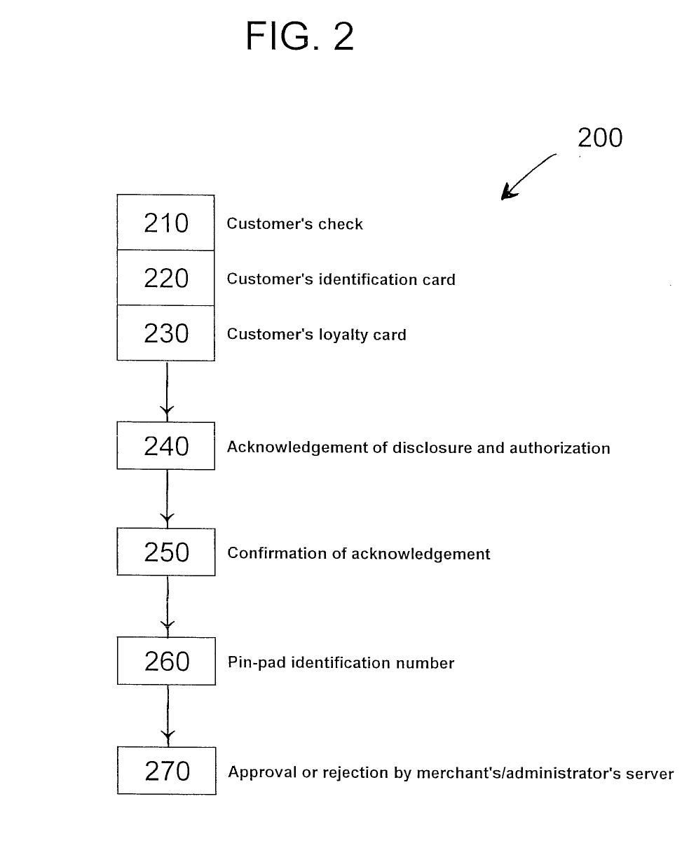

In FIG. 2 is depicted a schematic flow diagram 200 of the method step components of one embodiment of the invention. Depicted therein are initial steps #210 (customer's check), #220 (customer's id card), and #230 (customer's loyalty card), wherein information about the prospective new awards program customer is obtained for digital delivery to the system of the present invention for establishment of a new customer account.

Then, in compliance with NACHA or other regulations, acknowledgment in step #240 by the prospective new customer to full disclosure of the awards program details is provided for. Confirmation of this acknowledgment is provided for in step #250. This confirmation may be provided by the prospective new customer signing the check supplied for step #210 described above, and/or by franking the check in imager 12 in FIG. 1.

Then, in step #260 the prospective new customer will enter his/her own custom id number on pin-pad 20 in FIG. 1. This way, access to the new account will be provided only to the prospective new customer.

Then, when all of the above information has been obtained and provided digitally to the system's internet connection 18 in FIG. 1, the prospective new customer's account will be reviewed and, in step #270, approved or rejected by the merchant's/administrator's server. If approved, from that time on the customer will be able to use the merchant's loyalty card as a debit instrument at any merchant's participating location.

Although this invention has been described above with reference to particular means, materials and embodiments, it is to be understood that the invention is not limited to these disclosed particulars, but extends instead to all equivalents within the broad scope of this disclosure and the drawings.

I claim:

1. A customer acquisition method, comprising the steps of:
providing a customer with disclosure of the terms of a debit payment customer loyalty rewards program;
obtaining the customer's acknowledgement of the disclosure, and the customer's authorization of the loyalty rewards program; and
obtaining the customer's bank account and identification information;
wherein all of these steps are accomplished in one visit at the merchant's location.

2. The method of claim 1 wherein the customer's bank account information is obtained from the customer's check which is signed by the customer to confirm the authorization.

3. The method of claim 1 wherein the customer creates its own id number for the loyalty rewards program.

4. A customer acquisition system comprising:
a check imager for obtaining a customer's bank account and identification information;
a printer for providing a record for recording the customer's acknowledgement of the disclosure of the terms and conditions of a merchant's debt payment customer loyalty rewards program, and the customer's authorization of the loyalty rewards program; and
an Internet enabled communication and information processing device for transmitting the bank account and identification information, and acknowledgement and authorization records to the merchant's or its administrator's servers.

5. A customer acquisition system comprising:
a bar code reader for obtaining a customer's bank account and identification information;
a printer for providing a record for recording the customer's acknowledgement of the disclosure of the terms and conditions of a merchant's debt payment customer loyalty rewards program, and the customer's authorization of the loyalty rewards program; and
an Internet enabled communication and information processing device for transmitting the bank account and identification information, and acknowledgement and authorization records to the merchant's or its administrator's servers.

6. A customer acquisition system comprising:
a magnetic strip reader for obtaining a customer's bank account and identification information;
a printer for providing a record for recording the customer's acknowledgement of the disclosure of the terms and conditions of a merchant's debt payment customer loyalty rewards program, and the customer's authorization of the loyalty rewards program; and
an Internet enabled communication and information processing device for transmitting the bank account and identification information, and acknowledgement and authorization records to the merchant's or its administrator's servers.

7. A customer acquisition system, comprising:
an input device that obtains a customer's bank account and identification digital information, that obtains a merchant's debit payment loyalty program card digital information, and that obtains the customer's acknowledgement of disclosure about and authorization of the loyalty rewards program;
an Internet—enable communication and information processing device, for receiving and processing the digital bank account, identification and loyalty rewards program disclosure and authorization card information; and
an output device for providing the customer with the merchant's loyalty card, if the digital information is approved.
